(19) United States
(12) Patent Application Publication
(10) Pub. No.: US 2009/0248631 A1
(43) Pub. Date: Oct. 1, 2009

(54) System and Method for Balancing Workload of a Database Based Application by Partitioning Database Queries

(75) Inventors: Alfredo Alba, Morgan Hill, CA (US); Nikolaos Anerousis, Chappaqua, NY (US); Michael Ching, San Jose, CA (US); Genady Y. Grabarnik, Scarsdale, NY (US); Larisa Shwartz, Scarsdale, NY (US)

Correspondence Address: HARRINGTON & SMITH, PC, 4 RESEARCH DRIVE, Suite 202, SHELTON, CT, 06484-6212, US

(73) Assignee: International Business Machines Corporation

(21) Appl. No.: 12/059,282

(22) Filed: Mar. 31, 2008

(51) Int. Cl. G06F 7/06

(52) U.S. Cl. 707/3; 707/E17.014

(57) ABSTRACT

A method and system for processing complex long running queries with respect to a database in which the database workload is determined in terms of quality of service (QoS) requirements of with respect to short running queries, which can be of a transactional type, in which long running queries are partitioned into a plurality of sub-queries that satisfy the database QoS requirements, are then processed and the results of processing the plurality of sub-queries are aggregated so as to correspond to the processing of the long running query.

### FIELD OF THE INVENTION

The invention relates to the field of database processing of queries of long running and short running variety, such as of the transactional type, and the optimization of processing of long running queries while satisfying quality of service (QoS) requirements in terms of the specification for processing the short running transactional type queries.

### BACKGROUND

A critical constraint on modern real-time decision support systems is its ability to frequently process complex analytical queries against a large data warehouse, or database, while maintaining high throughput of shorter transactional type queries. Traditional data warehouses that support business intelligence (BI) applications primarily rely on batch updates to pre-compute dimensional aggregates and summaries of the stored data. However, real-time decision support systems require frequent updates to its analytical models. An example of a real-time decision support system that utilizes complex analytical data modeling while processing streaming transactional updates is a credit card fraud detection system. In such a system, as new transactions such as charges to a customer's account are committed to the data warehouse, they are evaluated against other recent transactions, as well as against historical spending patterns. This in turn triggers updates to existing fraud detection models for use in future transaction evaluation. Consequently, the system must frequently process complex sequel queries to access historical records and merge them with the processing of current transactions to update the detection models.

In the exemplary credit card system, consider a composite workload on the (database) server. The first component of load on the server is generated by a large number of short running queries, such as transactional queries. This load may be generated by queries to the database from an Internet web based application, such as J2EE or Web 2.0. These types of transactional queries can be, for example, recording a purchase transaction and checking the transaction amount against a current balance of the card holder, recording a payment, etc. The transactional queries are relatively simple, or short running, in terms of the code supplied to the data warehouse and usually have specific customer based service level requirements. In current practice the total processing time of a web requested short running transactional type query is commonly agreed upon to be under one second.

The second component of the server load is generated by long running reporting OLAP (On Line Analytical Processing) like queries. OLAP performs multidimensional analysis of business data and provides the capability for complex calculations, trend analysis, and sophisticated data modeling. Long running queries create continuous workload on the server that is difficult to manage. These longer queries slow down regular server work and also may increase the response time to the short running queries and cause the system to fail to meet the quality of service (QoS) requirement for the shorter running transactional type queries.

Existing solutions to the problem of serving the complexity of the types of short and long running queries include operating system OS-based threads and processes scheduling based on priority. Here each query is executed by some process or thread running on the server. These solutions use either processing of the higher priority jobs or queries first, or the scheduling of the time to perform jobs to be reciprocal to the job priority. In both cases the approach is not flexible enough to address the problem of simultaneous processing of jobs having the long running queries and jobs with short running transactional type queries that are supposed to satisfy certain QoS level requirements. Another option to solve the problem is to process some parts of the same query in parallel. However, this increases the amount of computing capacity that is required.

Therefore, a need exists to be able to process the longer running but lower priority analytical-type processes without interrupting the short-running but higher priority transactional-type queries/processes, and without causing those transactional-type queries to fail the service requirements/QoS which is objectively set forth in the service level agreement SLA.

### SUMMARY

Embodiments of the invention detailed herein are directed to a data processing system and method that optimizes concurrent processing of long running queries while satisfying QoS for the short running transactional type queries. The invention is illustratively described in terms of queries made using SQL (structured query language). However it as applicable to other similar type database management languages.

In accordance with an exemplary embodiment of the invention, complex SQL query statements are automatically partitioned into multiple sub-queries, or sub-statements, which can be independently processed and evaluated with a desired level of parallelism. There are several advantages to this approach. First, each of the sub-queries is far less complex than the original complex one and therefore has a much shorter processing time. Also, each of the sub-queries can be independently scheduled for processing. Therefore, they can be mixed among the incoming stream of the shorter transaction type queries in order to avoid lengthy database locks. Second, each sub-query can be independently evaluated in parallel and the sub-queries can be across a distributed cluster for processing.

In one advantageous embodiment of the invention, a complex query is presented. It is then partitioned into different types of sub-queries. These types can be based on different variables of the complex query. The sub-queries are preferably partitioned so as to all be of (substantially) the same size. The sub-queries produced by the partitioning are scheduled for processing which can be done using different places in the processing system and processing in different order. This further enables parallel computation which increases the data processing system throughput. The invention affords flexibility to the processing system in that a low priority sub-query can be run whenever there is time available in the system. In addition, the invention has the capability to take a complex long running query, partition it into a number of shorter running sub-queries and process the sub-queries while working around higher priority tasks being processed by the processing system (e.g., the transactional-type queries). The responses to the plurality of sub-queries are combined to give the answer to the original complex query.

The exemplary system and method are independent on the OS (operating system) of the server and does not require any modifications to the underlying database server. This is desirable because often the database server is shared by several applications, and so underlying changes to it are sometimes difficult to implement in practice.

### BRIEF DESCRIPTION OF THE DRAWINGS

Other objects and advantages of the present invention will become more apparent upon reference to the following specification and annexed drawings, in which:

FIG. 1 is a diagram of a typical data processing system that is applicable for use with the invention;

FIG. 2 is a flow chart illustrating the development of the partitions to make the sub-queries;

FIG. 3 is a diagram that further illustrates the principle used in the partitioning; and

FIG. 4 is a flow chart showing the overall operation of the method and system.

### DETAILED DESCRIPTION

Embodiments of the invention provide a data processing method and system with the ability to be able to process complex long running queries, which can be used to refresh analytical models of a data processing system database with real time updates, while concurrently supporting a high volume of the shorter running transactional type queries such as those noted by example above for a credit card processing system.

The described techniques of the invention may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The code or logic may be encoded from transmission signals propagating through space or a transmission media, such as an optical fiber, copper wire, etc. The transmission signal from which the code or logic is encoded may further comprise a wireless signal, satellite transmission, radio waves, infrared signals, Bluetooth, etc. The transmission signal from which the code or logic is encoded is capable of being transmitted by a transmitting station and received by a receiving station, where the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Further, although in describing the invention certain process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

Certain embodiments of the invention can take the form of an entirely hardware embodiment (e.g., an integrated circuit), an entirely software embodiment (e.g., an embodied software application) or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction processing system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

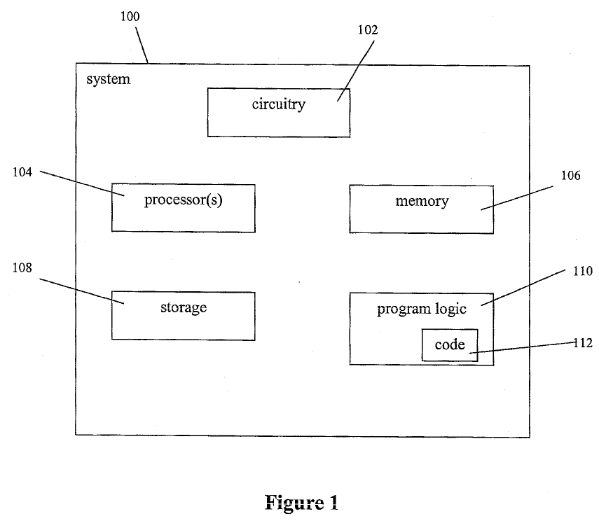

FIG. 1 illustrates a block diagram of a data processing system 100 in which certain embodiments of the invention may be implemented. The system 100 may include a circuitry 102 that may in certain embodiments include a processor 104. The system 100 may also include a memory 106 (e.g., a volatile memory device), and data sources 108 that contain the data of a database. The data sources 108 may include a non-volatile memory device (e.g., EEPROM, ROM, PROM, RAM, DRAM, SRAM, flash, firmware, programmable logic, etc.), magnetic disk drives, optical disk drives, tape drives, etc. The data sources 108 may comprise an internal storage device, an attached storage device and/or a network accessible storage device, or multiple storage devices that are co-located or dispersed (e.g, disc array or multiple servers). The system 100 may include a program logic 110 including code 112 that may be loaded into the memory 106 and executed by the processor 104 or circuitry 102. In certain embodiments, the program logic 110 including code 112 may be stored in the data sources storage 108. In certain other embodiments, the program logic 110 may be implemented in the circuitry 102. Therefore, while FIG. 1 shows the program logic 110 separately from the other elements, the program logic 110 may be implemented in the memory 106 and/or the circuitry 102.

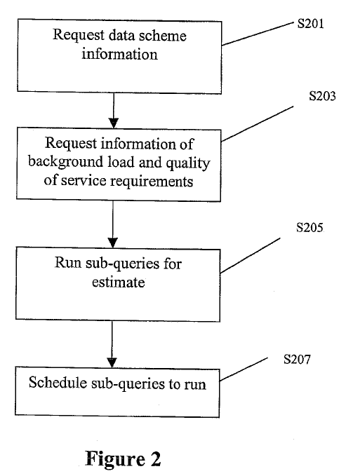

FIG. 2 shows he overall flow of the execution of the partitioning of a complex query. In S201 a query provider (the part of the data processing apparatus and/or operating program that makes the request that will ultimately lead to partitioning of a complex query) addresses the system and requests information about the query data scheme in order to determine out how the query may be partitioned. The information is automatically requested as an estimate of how small sub-query runs will affect overall system operation. In practice a Service Level Agreement (SLA) is in existence between a customer and a service provider which defines performance of the processing system at both the provider system operational level and customer level. The customer typically is only concerned with the customer level SLA and benchmarked requirements, and the service provider must satisfy the customer. Therefore, the SLA might very well be a compromise that will meet the customer's QoS requirement but at the same time not burden the operational SLA with excess overhead in running the additional sub-queries.

In S203 the query provider requests information from the database about quality of service (QoS) requirements for the background load queries (e.g., the short transactional-type queries) and historical data concerning the size of the background load. For example, QoS requirements could state that every load query should be processed within 0.5 seconds. Any other suitable time duration can be used, depending upon the system requirements. In the example, historical data from the database shows that during peak load one thousand queries process within one second, where each query takes at most 0.3 seconds and switching of the query takes 0.04 seconds. This means that if complex long running queries are partitioned into sub-queries that take less than ˜0.1 second to process and there is a schedule to process one thousand such sub-queries, the resulting system will still be able to sustain the response time necessary to satisfy the quality of service requirements in the customer level SLA for the transactional-type queries.

An example of a complex query, using SQL as the exemplary language, is:

```
    SELECT SUM(EXEC_TIME) AS SUM, ORG_ID,
USER_ID FROM TABLE1
    GROUP BY ORG_ID, USER_ID
    ORDER BY ORG_ID, USER_ID.
```

The statement terms ORG_ID and USER_ID, which are variables, would each be a column of the data table.

The example query is partitionable by values of ORG_ID and USER_ID. Possible partitions of the example query into sub-queries with the smallest possible granularity are expressed as:

```
    SELECT SUM(EXEC_TIME) AS SUM, ORG_ID, USER_ID
FROM TABLE1 WHERE ORG_ID = ‘a’ AND USER_ID = ‘c’
    GROUP BY ORG_ID, USER_ID
    ORDER BY ORG_ID, USER_ID.
```

Here the term ‘a’ is a possible value of ORG_ID and the term ‘c’ is a possible value of USER_ID. It is assumed that ORG_ID and USER_ID are independent variables. As seen, the complex query has been partitioned into two sub-queries, GROUP and ORDER.

In S205 the query provider runs a number of sub-queries on the database with the smallest granularity (length) to obtain an estimate of how long it takes to process the partitioned sub-queries. Based on the sub-query time of execution, the query provider preferably combines similar sub-queries as follows, using the above example:

```
    SELECT SUM(EXEC_TIME) AS SUM, ORG_ID, USER_ID
FROM TABLE1 WHERE ORG_ID in ‘a’, ‘b’ AND USER_ID in ‘c’, ‘d’
    GROUP BY ORG_ID, USER_ID
    ORDER BY ORG_ID, USER_ID
```

Here, the terms ‘a’ and ‘b’ are possible values of the variable ORG_ID and the terms ‘c’ and ‘d’ are possible values of the variable USER_ID

This is done in such a way that total processing time of the sub-query in addition to the load query and double query change time does not the exceed QoS time information obtained in S201. The query provider also defines the number of sub-queries to run per second.

Finally, in S207 the query provider schedules the sub-queries to run in a uniform manner. That is, the sub-queries preferably are assembled in groups of the same data length for processing. They preferably are also scheduled for processing at different places in the operating system and in a different order so as to maximize efficiency of the processing system.

If the partitioning were restricted only to combinations of columnar values of the data, the end result would in many cases be ineffective for the purposes set forth above (meeting SLA QoS requirements for the transactional-type queries). Instead, from each part of the data there is chosen so many columns that define the partition, and also there is chosen all n-tuples of those columns as being representative of a partition. This enables the different partitions to be run in a manner that they will each enable an independent result once the partitioned sub-query is analyzed. These independent results are then aggregated or otherwise combined to get the overall result, which is the same as if the overall query were run without partitioning.

Consider as an example the case when where clause to be partitioned consists of a set of theoretical operations:

```
    Partition (cmp[1], [3]): select
SELECT [ DISTINCT | ALL ] ( ‘*’ | functions |
value_literal { ‘,’ value_literal } )
FROM from_table_reference { ‘,’ from_table_reference } defines space
        as a multiplication of the tables with possible join, may contain
        further select
    [ WHERE search_condition ] defines filtering by predicates truth
values [see for example US Pat. No. 6,546,403], may contain
further select
    [ GROUP BY column_name]
    [ HAVING search_condition ]
    [ UNION select_expression [ ALL ] ]
    [ ORDER BY order_list ].
```

In the above example, the operation ORDER BY has no effect on the partitioning, the operation UNION is considered for partitioning because it is generated by combining the terms of that operation, and so can often be readily broken into sub-queries (e.g., {a,b} V {b,c} can be partitioned as {a}, {b}, {c}). The operation HAVING is a filter, restricting the final result choice. In the example this operation simply removes parts of the partition (e.g., entire groups that are organized by the GROUP BY operator of the partition). The operation GROUP BY can be used to generate a partition because it groups rows together based on the column's equality. The FROM operator defines a space of rows as a subset in a Cartesian product of tables, and so is taken from one larger table. The WERE operator (without subqueries) defines the matching rows in the larger table by predicates or functions on the columns. The SELECT function chooses columns to show, or has aggregate functions for the columns.

To further explain the partitioning of a complex long running query, assume that there is only one column due to a WHERE clause, and so the query runs a subset of that one column, such as a final combination of the operators {=, < >, between} etc. These operators can be used as a definition of a partition, and we choose this column to be representative of the WHERE clause restriction so as to generate sub-queries from it.

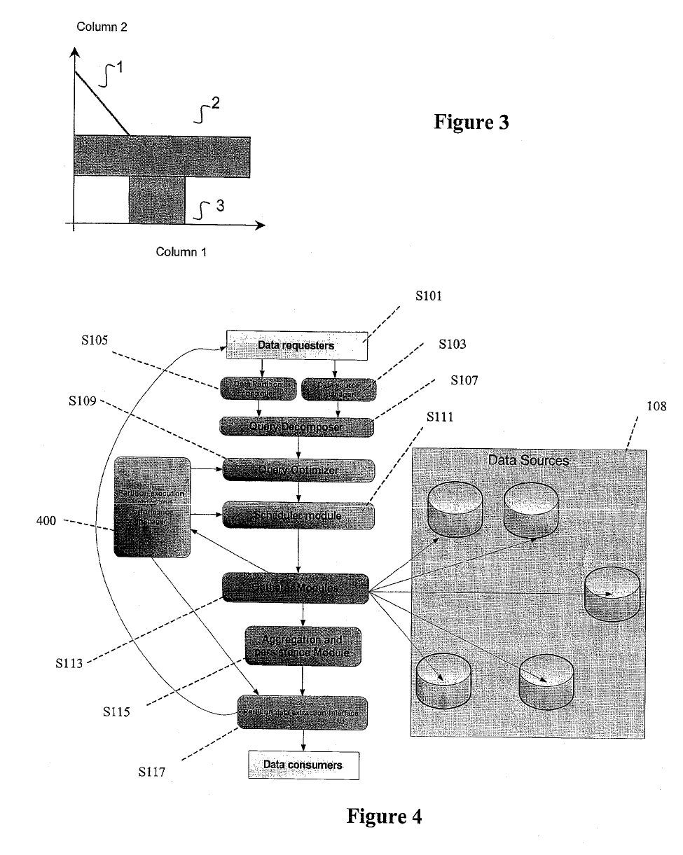

FIG. 3 illustrates the case in which there are more than one column of data selected by such a WHERE clause or a SELECT clause. These columns may be represented as shown in FIG. 3 as a union of different intersections and joins. Some prefix order of columns can be used such as column 1 (horizontal axis) and column 2 (vertical axis) in FIG. 3. For a JOIN expression, we can consider a projection on either column (e.g., left JOIN to the left column, full JOIN for the left column and the missing part of the right column, etc.). Then we project tuples of columns. This is shown in FIG. 3 by reference number 1, where column 1 is chosen as representative in order to describe the choice for each column. Another possibility is to use the restricted column 2 values, as shown by reference number 2 of FIG. 3. Yet another choice is to restrict the values of columns 1 and 2, as shown by reference number 3 of FIG. 3.

Now, for a SELECT clause, the aggregation is dealt with by omitting the aggregation and processing the aggregation externally. These are distinct, so after the choice of columns all of the aggregations are used on the partition.

FIG. 4 shows a preferred system and flow type chart for implementing the invention and showing its operation. The processing system of FIG. 1 data sources 108 contains a number of data storage devices of any conventional type such as servers or fixed drives of the required capacity. These can be arranged in any suitable combination and/or configuration and accessed in any conventional manner as required to obtain data from any one of the processing system database storage devices. The operation of the method and system is controlled by a partition execution metrics and performance manager 400. This can be a suitable computer application program that can have an input interface (not shown). The performance manager instructs the database as to when to schedule processing of the sub-queries. This is based on current workload of the database and using known processing time of sub-queries with the object of combining sub-query processing whenever possible but always meeting customer level SLA.

In S101 the data requesters provide the queries for data to be obtained from the source 108. These queries can be any number of the transactional queries, which are relatively short in running time, or more complex queries such as for multidimensional analysis of the data that is stored in the source 108.

In S103 the data requesters provide to the data source definitions to the data source manager 400 and in S105 provide the data partition definitions. The partitioning is done system. The partitioning is done as described above.

In S107, after the partition definition information is received, the longer running length complex queries are decomposed into a plurality of the short running sub-queries. In S109 the partitioned queries are optimized by being combined to fill up available processing system overhead. In S111 the plurality of partitioned sub-queries are scheduled for processing. During the optimization and scheduling process expected and historical performance and data source load are considered in a formal feedback loop manner between the query requester and the database. Combining the sub-queries and scheduling them is done in real time.

Once the optimization and scheduling has been completed, in S113 the resulting queries preferably are bound to the proper gatherers. That is, the sub-queries may be of different length and to increase processing efficiency for processing the sub-queries can be combined either to have different batches of sub-queries of the same length or to have a number of the sub-queries fit a predetermined length. This is done by an auto-execution routine. At this time the sub-queries are processed relative to the data source 108. The normally occurring short running transactional queries are being processed at the same.

After the sub-queries are processed at the data source 108, in S115 the results are directed to an aggregation and persistence module in which the data is finalized and persisted for final consumption by the data processing system. That is, the answers derived from processing of the various sub-queries partitioned form a complex query are assembled to produce data that is effectively processing of the complex query.

In S117 the final data, which is the processing of the complex query, is extracted through a data extraction interface which ultimately delivers the aggregated partition data for final consumption by the data processing system. The interface can be delivery to a part of the data modeling program, such as the credit card application described above, to update the modeling program. The final output includes the responses to all of the short running sub-queries as well as responses to the more complex queries.

Specific features of the invention are shown in one or more of the drawings for convenience only, as each feature may be combined with other features in accordance with the invention. Alternative embodiments will be recognized by those skilled in the art and are intended to be included within the scope of the claims. Accordingly, the above description should be construed as illustrating and not limiting the scope of the invention. All such obvious changes and modifications are within the patented scope of the appended claims.

We claim:

1. A method for processing complex long running queries with respect to a database of a data processing system comprising:
partitioning a long running query into a plurality of sub-queries;
processing said plurality of sub-queries in the data processing system and obtaining results for each processed sub-query while also processing transactional queries in a manner to satisfy at least one quality of service QoS requirement; and
assembling the results to provide data that corresponds to processing of the long running query.

2. The method of claim 1, wherein the at least one QoS requirement comprises an execution time for the transactional queries and the long running query comprises an analysis of a plurality of transactional queries.

3. The method of claim 1, wherein:
the execution time is less than or equal to 1.0 seconds; and
processing the plurality of sub-queries while also processing transactional queries comprises dynamically scheduling the sub-queries for processing in cooperation with processing the transactional queries to meet the at least one QoS requirement and feedback of overall load on the data processing system due to processing at least the transactional queries.

4. The method of claim 1, wherein the partitioning further comprises partitioning user data sets, and wherein the assembling is performed separately from the processing of the transactional queries.

5. The method of claim 1, further comprising assembling said plurality of sub-queries into groups of same data length or same execution time before processing said sub-queries.

6. The method of claim 5, further comprising opportunistically processing the sub-queries at times selected based on a current workload of processing the transactional queries, wherein a given sub-query is selected based on the given sub-query execution time in view of the current workload.

7. The method of claim 1, wherein processing the plurality of sub-queries comprises processing the sub-queries in parallel at different locations of the data processing system.

8. A data processing system for processing complex long running queries comprising:
a database; and
a computer that operates to partition a long running query into a plurality of sub-queries, to process said plurality of sub-queries and obtain results for each processed sub-query while also processing transactional queries in a manner to satisfy at least one customer quality of service QoS requirement, and to assemble the results to provide data that corresponds to processing of the long running query.

9. The system of claim 8 wherein the at least one QoS requirement comprises an execution time for the transactional queries and the long running query comprises an analysis of a plurality of transactional queries.

10. The system of claim 8 wherein:
the execution time is less than or equal to 1.0 seconds; and
processing the plurality of sub-queries while also processing transactional queries comprises dynamically scheduling the sub-queries for processing in cooperation with processing the transactional queries to meet the at least one QoS requirement and feedback of overall load on the data processing system due to processing at least the transactional queries.

11. The system of claim 8, wherein the computer operates to partition user data sets when partitioning the long running query.

12. The system of claim 8 wherein said computer also operates to assemble said plurality of sub-queries into groups of same data length or same execution time before processing said sub-queries.

13. The system of claim 12, wherein said computer opportunistically processes the sub-queries at times selected based on a current workload of processing the transactional queries, wherein the computer selects a given sub-query for processing based on the given sub-query execution time in view of the current workload.

14. The system of claim 9 wherein said computer processes sub-queries on the basis of a predetermined number of sub-queries per unit time within the QoS requirement.

15. A signal bearing medium tangibly embodying a program of machine-readable instructions executable by a digital processing apparatus to perform operations to process long running queries, the operations comprising:
partitioning a long running query into a plurality of sub-queries;
processing said plurality of sub-queries and obtaining results for each processed sub-query while also processing transactional queries in a manner to satisfy at least one quality of service QoS requirement; and
assembling the results to provide data that corresponds to processing of the long running query.

16. The signal bearing medium of claim 15 wherein the at least one QoS requirement comprises an execution time for the transactional queries and the long running query comprises an analysis of a plurality of transactional queries.

17. The signal bearing medium of claim 15 wherein:
the execution time is less than or equal to 1.0 seconds; and
processing the plurality of sub-queries while also processing transactional queries comprises dynamically scheduling the sub-queries for processing in cooperation with processing the transactional queries to meet the at least one QoS requirement and feedback of overall load on the data processing system due to processing at least the transactional queries.

18. The signal bearing medium of claim 15 wherein the partitioning further comprises partitioning user data sets, and wherein the assembling is performed separately from the processing of the transactional queries.

19. The signal bearing medium of claim 15 wherein the operations further comprise assembling said plurality of sub-queries into groups of same data length or same execution time before processing said sub-queries.

20. The signal bearing medium of claim 15 wherein the operations further comprise opportunistically processing the sub-queries at times selected based on a current workload of processing the transactional queries, wherein a given sub-query is selected based on the given sub-query execution time in view of the current workload.

21. The signal bearing medium of claim 16 wherein processing the plurality of sub-queries comprises processing the sub-queries in parallel at different locations of the data processing system.
